(19) United States
(12) Patent Application Publication
(10) Pub. No.: US 2018/0240131 A1
(43) Pub. Date: Aug. 23, 2018

(54) IDENTIFYING DECEPTIVE SOCIAL MEDIA CONTENT

(71) Applicant: International Business Machines Corporation, Armonk, NY (US)

(72) Inventors: Gary Denner, Longwood (IE); Jonathan Dunne, Dungarvan (IE); Robert H. Grant, Austin, TX (US); Trudy L. Hewitt, Cary, NC (US)

(21) Appl. No.: 15/435,524

(22) Filed: Feb. 17, 2017

(51) Int. Cl. G06Q 30/00; G06Q 50/00

(52) U.S. Cl. CPC G06Q 30/0185; G06Q 50/01

(57) ABSTRACT

Approaches presented herein enable identifying a deceptive social media post such as a fraudulent social survey in a social media environment. Specifically, a regression model including one or more factors, each of the one or more factors includes a respective parameter, is generated based on an analysis of prior social media scam data. A predictor function including a threshold value is generated based on the regression model. A repudiation value for a particular social media post is calculated using the predictor function based on one or more factors and respective parameters. If the repudiation value exceeds the threshold value, a repudiation is provided indicating the social media post is potentially fraudulent.

### TECHNICAL FIELD

This invention relates generally to electronic content delivery and, more specifically, to automatically identifying a deceptive social media post such as a fraudulent social survey in a social media environment.

### BACKGROUND

For some time now, the Internet has been used as a mechanism for people to express their opinion and views, and to provide information. Conventionally, sites on the Internet were created by technically proficient individuals, or businesses, and users of the Internet were able to visit those sites to obtain information or contact or conduct commerce with the individuals or businesses to which the sites related. However, the development of web logging (“blogging”) and discussion forum platforms has facilitated the generation of hosted content by individual (and not necessarily technically proficient) web users. Content generation by individuals has also increased with the increased use of social networking sites such as Facebook® and LinkedIn®, and microblogging platforms such as Twitter®. Such platforms and sites are generally collectively known as “social media”, a key characteristic of which is that ordinary users of the Internet are not just consumers but also producers of information.

In the networked computing environment of today, these social media platforms can provide users with an easy-to-use interface for sharing and/or accessing information on virtually any topic. For example, if a user wants to develop an understanding on a particular topic, then the user can log on to these platforms from a personal computer, cell phone, or other communication device to access various articles, news, blogs, and/or the like, on the Internet related to the topic. However, due to this ease of sharing of information, the amount of information that has been shared has increased exponentially.

### SUMMARY

In general, approaches presented herein enable identifying a deceptive social media post such as a fraudulent social survey in a social media environment. Specifically, a regression model including one or more factors, each of the one or more factors includes a respective parameter, is generated based on an analysis of prior social media scam data. A predictor function including a threshold value is generated based on the regression model. A repudiation value for a particular social media post is calculated using the predictor function based on one or more factors and respective parameters. If the repudiation value exceeds the threshold value, a repudiation is provided indicating the social media post is potentially fraudulent.

One aspect of the present invention includes a computer-implemented method for repudiating social media content, the method comprising: receiving a predictor function, wherein the predictor function includes one or more factors, wherein each of the one or more factors includes a respective parameter; analyzing a social media post to determine whether at least one of the one or more factors applies to the social media post; calculating, based on the analysis, a repudiation value for the social media post using the predictor function; and providing a repudiation of the social media post when the repudiation value exceeds the threshold value.

Another aspect of the present invention includes a computer program product for repudiating social media content, and program instructions stored on the computer readable storage device, to: receive a predictor function, wherein the predictor function includes one or more factors, wherein each of the one or more factors includes a respective parameter; analyze a social media post to determine whether at least one of the one or more factors applies to the social media post; calculate, based on the analysis, a repudiation value for the social media post using the predictor function; and provide a repudiation of the social media post when the repudiation value exceeds the threshold value.

Yet another aspect of the present invention includes a computer system for repudiating social media content, the computer system comprising: a memory medium comprising program instructions; a bus coupled to the memory medium; and a processor for executing the program instructions, the instructions causing the system to: receive a predictor function, wherein the predictor function includes one or more factors, wherein each of the one or more factors includes a respective parameter; analyze a social media post to determine whether at least one of the one or more factors applies to the social media post; calculate, based on the analysis, a repudiation value for the social media post using the predictor function; and provide a repudiation of the social media post when the repudiation value exceeds the threshold value.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture 10 in which the invention may be implemented according to illustrative embodiments;

FIG. 2 shows a schematic diagram 200 illustrating an exemplary environment for implementation according to illustrative embodiments;

FIG. 3 shows a table 300 representing an example regression model including the factors determined to influence a response variable according to illustrative embodiments;

FIG. 4 shows an example social media post 400 according to illustrative embodiments;

FIG. 5 shows a table 500 including how a set of factors apply to social media post 400 according to illustrative embodiments;

FIG. 6 shows an example social media post 600 including a scam alert according to illustrative embodiments; and

FIG. 7 shows a process flowchart 700 for identifying a deceptive social media post such as a fraudulent social survey in a social media environment according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing”, “detecting”, “determining”, “evaluating”, “receiving”, or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission, or viewing devices. The embodiments are not limited in this context.

As stated above, embodiments of the present invention enable identifying a deceptive social media post such as a fraudulent social survey in a social media environment. Specifically, a regression model including one or more factors, each of the one or more factors includes a respective parameter, is generated based on an analysis of prior social media scam data. A predictor function including a threshold value is generated based on the regression model. A repudiation value for a particular social media post is calculated using the predictor function based on one or more factors and respective parameters. If the repudiation value exceeds the threshold value, a repudiation is provided indicating the social media post is potentially fraudulent.

Social networking sites are now a primary source for communicating and keeping in touch with friends and family. People share pictures, post updates, and reveal all sorts of personal information about themselves, which makes these sites prime targets for criminal activity. Scams continuously attempt to lure users to ad tracking sites and survey pages in an attempt to earn profit and steal data. An effective scam sometimes found on social networking sites is what is known as a “social survey scam”. Social survey scams typically come in the form of wall posts with a link. They use clever social engineering techniques like mentioning popular news items about celebrities, or political issues. Another popular hook is mentioning a contest or prize giveaway. By hooking social survey scams with effective social engineering lures, users are likely to click the links or follow the instructions included in the posts.

The inventors of the invention described herein have recognized certain deficiencies in known methods for determining whether certain digital content such as a social survey is indeed fraudulent (i.e., a scam). Profit is the main driver for these types of scams. Cybercriminals behind these scams earn money by driving users to ad-tracking sites or affiliate sites before actually proceeding to the survey. Cybercriminals set up the social survey scam pages for the sole purpose of theft as they may use the gathered information for their future schemes. For example, cybercriminals may distribute spammed messages to the email addresses that they obtained from the social survey scams. The messages may contain malicious file attachments or data-stealing malware. Scammers can also profit by tricking victims into registering for bogus premium text services. This is why many of these scammers ask users to give out their mobile phone numbers. The approaches described herein provide a seamless way for identifying a deceptive social media post such as a fraudulent social survey in a social media environment. Although this disclosure includes automatically identifying fraudulent social media content, the discussions and examples provided herein typically refer to fraudulent social surveys or social survey scams for the sake of simplicity.

In certain embodiments, an advantage of this approach is its protection of users consuming a targeted social media site. Users who fall victim to social survey scams are at risk of having their information stolen. These survey pages are known to ask for personal and sensitive information, which cybercriminals may use in their future malicious activities. Since these scams also require users to disclose their email addresses, scammers may use these for spamming. The protection may also extend to a given user's contacts (e.g., friends, family, co-workers, etc.) since once users follow the instruction to share the malicious post, the post may automatically be spread to the user's contacts.

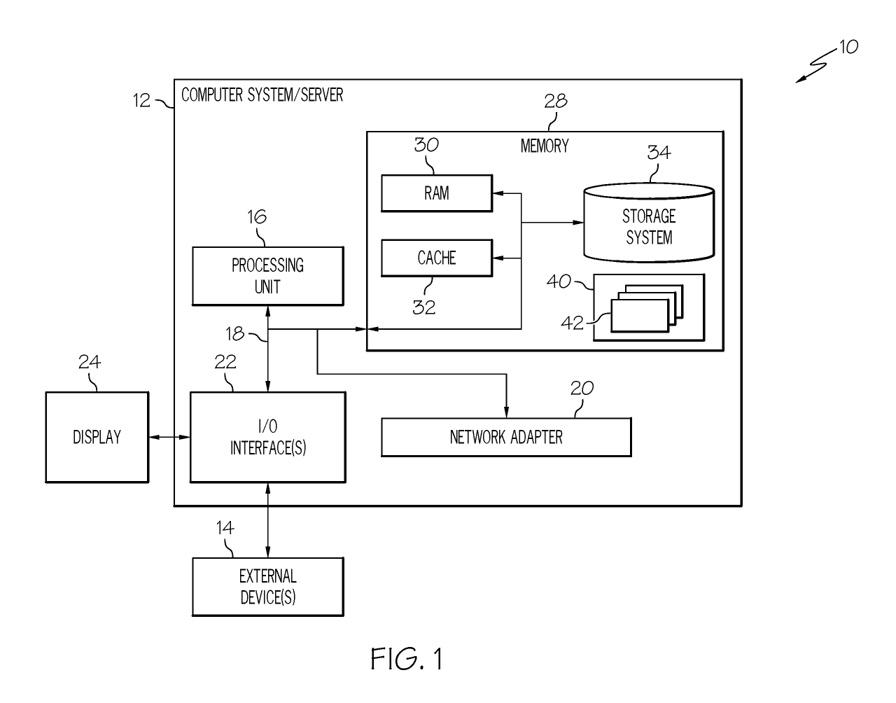

Referring now to FIG. 1, a computerized implementation 10 of an embodiment for identifying a deceptive social media post such as a fraudulent social survey in a social media environment will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein.

Computer system/server 12 may be described in the general context of computer system executable instructions, such as program modules, being executed by a computer system. Generally, program modules may include routines, programs, objects, components, logic, data structures, and so on, that perform particular tasks or implement particular abstract data types. In this particular example, computer system/server 12 represents an illustrative system for identifying a deceptive social media post such as a fraudulent social survey in a social media environment. It should be understood that any other computers implemented under the present invention may have different components/software, but can perform similar functions.

Computer system/server 12 in computerized implementation 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for identifying a deceptive social media post such as a fraudulent social survey in a social media environment, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

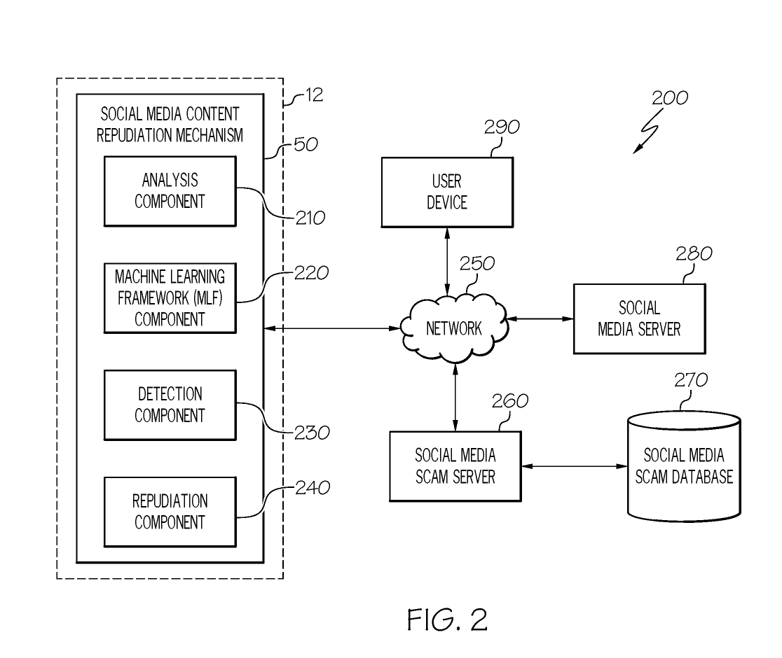

Referring now to FIG. 2, a block diagram 200 describing the functionality discussed herein according to an embodiment of the present invention is shown. It is understood that the teachings recited herein may be practiced within any type of computing environment (e.g., computer system 12). To this extent, the teachings recited herein may be practiced within a stand-alone computer system or within a networked computing environment (e.g., a client-server environment, peer-to-peer environment, distributed computing environment, cloud computing environment, and/or the like). If the teachings recited herein are practiced within a networked computing environment, each physical server need not have a social media content repudiation mechanism 50 (hereinafter “system 50”). Rather, system 50 could be loaded on a server or server-capable device that communicates (e.g., wirelessly) with the physical server to indicate a repudiation of social media content.

Regardless, as depicted, system 50 can be implemented as program/utility 40 on computer system 12 of FIG. 1 and can enable the functions recited herein. It is further understood that system 50 can be incorporated within or work in conjunction with any type of system that receives, processes, and/or executes commands with respect to IT resources in a networked computing environment. Such other system(s) have not been shown in FIG. 2 for brevity purposes. As shown, social media content repudiation mechanism 50 includes analysis component 210, machine learning framework (MLF) component 220, detection component 230, and repudiation component 240. The functions/acts of each component is described in detail below.

As shown, social media content repudiation mechanism 50 may be communicatively coupled with a social media scam server 260 and a social media server 280 via a network 250. The network 250 may be any type of network or any combination of networks. Specifically, the network 250 may include wired components, wireless components, or both wired and wireless components. In an embodiment, social media scam server 260 generally operates to obtain/maintain data related to prior social media scams in social media scam database 270. In an embodiment, one or more social media servers 280 (e.g., Facebook®, Twitter®, etc.) generally operate as social media platforms which may provide social media content and associated metadata to social media content repudiation mechanism 50 when identifying deceptive social media posts.

Also, as shown, user device 290 may include any computing device capable of connecting to one or more social media servers 280 via network 250 to enable aggregation and management of social media information. User device 90 may be a mobile smart phone, portable media player device, portable fitness device, mobile gaming device, personal computer, laptop computer, tablet, or the like. Some exemplary devices that may be programmed or otherwise configured to operate as user device 290 are the Apple® iPhone®, the Motorola Droid or similar smart phone running Google's Android™ Operating System, an Apple® iPad™, and the Apple® iPod Touch® device. However, this list of exemplary devices is not exhaustive and is not intended to limit the scope of the present disclosure.

Data stored in social media scam database 270 may include data related to prior identified social media scam posts including, but not limited to, actual content of the post, metadata of the post, and/or interactions related to the post, such as likes, shares, comments, and/or the like. The data may be collected from social media platforms (e.g., Facebook®, Twitter®, etc.) or any other available source such as governmental resources or the like. The collection mechanism may comprise a semantic crawler to collect social media content located at different sites on the Internet gathering information related to known fraudulent social media posts, such as actual content of the post along with its metadata, with the crawler acting to update such information on a regular basis.

Social media scam database 270 may include a relational database, which can be implemented in a combination of hardware (i.e., physical data storage hardware) and software (i.e., relational database software). Although social media scam database 270 is shown as separate from social media scam server 260, social media scam database 270 may be integral to or separate from social media scam server 260.

In any case, data stored in social media scam database 270 can be analyzed to determine which factors contribute to inferring a social media scam. To that end, a regression model represented by an equation can be generated to describe the statistical relationship between one or more factors (or “predictor variables”) and the response variable using regression analysis. Regression analysis is a statistical tool for the investigation of relationships between variables. Typically, an investigator seeks to ascertain the causal effect of one variable upon another, such as the effect of a price increase upon demand.

To explore such issues, the investigator assembles data on the underlying variables of interest and employs regression analysis to estimate the quantitative effect of the causal variables (hereinafter, referred to as “factors”) upon the response variable that they influence. The investigator also typically assesses the “statistical significance” of the estimated relationships, that is, the degree of confidence that the true relationship is close to the estimated relationship. The response variable is the variable that the analysis attempts to predict. For purposes of this disclosure, the response variable relates to whether a given social media post is a social media scam.

As stated, a regression model attempts to explain the relationship between two or more variables. Generation of a regression model may include selecting which factors to include in the regression model and then generating the interactions between the selected factors. The factors to be used in the regression model may be determined manually (e.g., using a graphical user interface) and/or using an automated iterative process. For example, automated multiple factor regression analysis techniques, such as best subsets regression, stepwise regression, or the like, may be employed to determine which factors contribute most to inferring a social media scam.

Best Subsets compares all possible models using a specified set of predictors, and displays the best-fitting models that contain one predictor, two predictors, and so on. The end result is a number of models and their summary statistics. Stepwise regression selects a model by automatically adding or removing individual predictors, a step at a time, based on their statistical significance. The end result of this process is a single regression model, which makes it simple. The general approach is to select the smallest subset that fulfills certain statistical criteria. The reason to use a subset of variables instead of a complete set is because the subset model may predict future responses with smaller variance than the full model using all predictors.

A regression model typically involves the following variables: the unknown parameters (denoted β), the factors (denoted as X), and the response variable (denoted as Y). The magnitude of a given parameter associated with a respective factor indicates the strength of the association between the factor and the response variable. One function of regression analysis is to find a solution for unknown parameters β that will, for example, minimize the distance between the measured and predicted values of the response variable Y.

Analysis component 210 of system 50, as executed by computer system/server 12, is configured to analyze prior social media scam data using regression analysis to generate a regression model including one or more parameters. In an embodiment, analysis component 210 analyzes prior social media scam data residing in social media scam database 270 using regression analysis to determine which factors to include in a regression model along with the interactions between the factors including estimating the quantitative effect of each factor (i.e., a parameter value) upon a response variable that it influences. Data related to a prior social media scam post may include, but not limited to, actual content of the post including any text, images, and/or links (e.g., external URL), metadata of the post (e.g., creator(s), title, description, date/time of post, etc.), interactions (e.g., use, viewership, etc.) related to the post including likes, shares, comments, etc., analysis between two or more social media platforms (e.g., a Facebook® post having a similar Twitter® post in which the Twitter® post contains suspicious links), and/or any known “red flags” which may indicate the particular social media content is fraudulent. The data may be collected from social media platforms (e.g., Facebook®, Twitter®, etc.) or any other available source such as governmental resources or the like.

As used herein, a “red flag” may be defined as any easily identifiable characteristic that may indicate a high likelihood that a particular social media post is, in fact, a scam. For example, a red flag may include, but is not limited to, any suspicious links (e.g., bit.ly or otherwise shortened links that don't display the actual address), a “bare bones” post (e.g., a one page signup form), missing company information, missing privacy policy information, and/or surefire guarantees or too-good-to-be-true promises, such as free high-dollar giveaways or prizes. In an embodiment, natural language processing (NLP) and/or image processing techniques may be employed to analyze the content of a particular social media post to determine whether one or more red flags exists. For example, a social survey post claiming to be from a company giving away a valuable prize to the first ten people responding to a survey should include identifier information related to the company along with privacy policy information. NLP techniques may be used to determine whether that information is lacking from the post. Similarly, a post related to a particular company may be compared against previous offerings from the company using NLP techniques to determine whether the post being analyzed is consistent with those previous offerings or out of the ordinary for the company.

In an embodiment, analysis component 210 may determine a social media volume trajectory for a social media post identified as having at least one red flag by gathering social metadata related to the social media post's views, likes, shares, etc. For example, a social media volume value may be calculated (e.g., by adding together the total number of views, likes, and shares) for a social media post claiming to be from a well-known company, but lacking any identifier or privacy policy information. Successive social media volume values may be calculated over one or more predefined time intervals to determine a social media volume trajectory. A steep social media volume trajectory (e.g., having a 50 degree slope over a several hours) may indicate an additional red flag. Although one red flag may not be determinative of whether a particular post being analyzed is fraudulent, additional red flags or information extracted from the content and/or metadata related to the post may indicate a likelihood the post is indeed a scam.

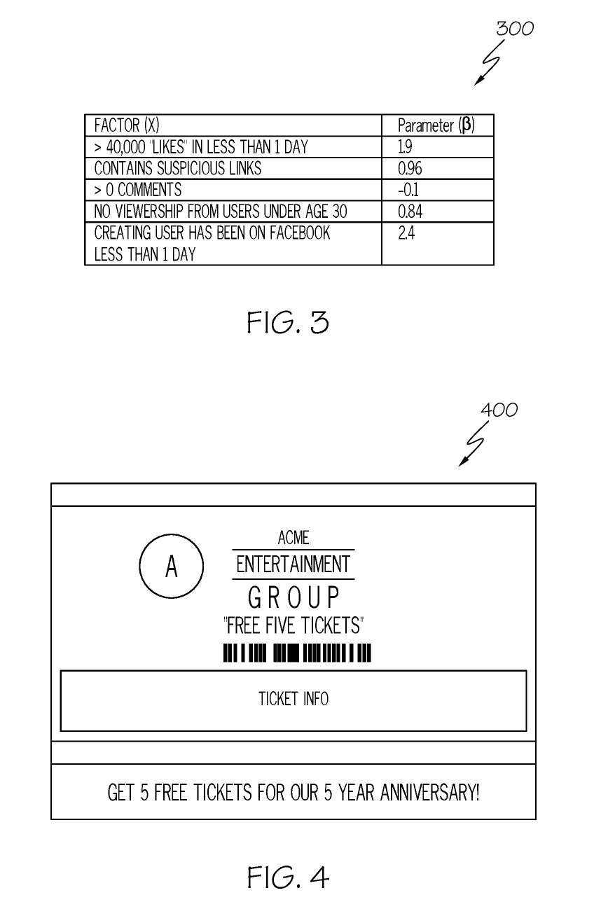

FIG. 3 shows table 300 representing an example regression model including the factors determined to influence a response variable. As shown, analysis component 210 determines 5 factors which have been identified to influence whether a social survey post being analyzed can be repudiated as a potential scam based on a regression analysis performed against social media scam database 270. Furthermore, a magnitude for each factor, as expressed by a respective parameter, is estimated using regression analysis to indicate a strength of the association between the factor and the response variable.

Machine learning framework (MLF) component 220 of system 50, as executed by computer system/server 12, is configured to receive a set of parameters related to a regression model to generate a predictor function used to determine a validity of social media content. Machine learning, a branch of artificial intelligence, concerns the construction and study of systems that can learn from data. For example, a machine learning system could be trained on email messages to learn to distinguish between spam and non-spam messages. Machine learning, more specifically the field of predictive modeling, is primarily concerned with minimizing the error of a model or making the most accurate predictions possible. For our purposes, machine learning framework (MLF) component 220 may receive a set of parameters related to a regression model to generate a predictor function which may be used to determine the likelihood a social media post (e.g., a social survey) is a scam. A goal of MLF component 220 is to develop a finely tuned predictor function. “Learning” consists of using sophisticated mathematical algorithms to optimize the predictor function so that, given a set of input parameters related to prior scams, the predictor function will accurately predict whether a particular social media post being analyzed is valid or fraudulent.

For example, MLF component 220 may generate the following predictor function based on the set of parameters shown in table 300: Predictor value=1.91X1+0.96X2+0.1X3+0.84X4+2.4X5+error factor. Each factor coefficient (or parameter) indicates the strength of the association between the factor and the response variable. For example, factor X1 (i.e., with parameter 1.91) provides a stronger indication than factor X2 (i.e., with parameter 0.96) that the post being analyzed may be fraudulent if factor X1 is present as compared with factor X2. If the predictor value is greater than a predefined threshold, this indicates the post being analyzed is likely, based on prior social media scams, to be fraudulent. In an embodiment, one or more thresholds may be defined by MLF component 220. For example, a predictor value greater than 3.1 may indicate a 75% likelihood the post being analyzed is likely a scam, where a value greater than 5.0 may indicate a 95% likelihood. In an embodiment, the predictor function including any threshold values may consistently be trained or tuned based on an accuracy of its predictions. For example, a person may manually determine whether the post is indeed fraudulent when a predictor value is found greater than a threshold. Feedback on the accuracy of each prediction may be input (e.g., via an interface) into MLF component 220 in order to further tune the function.

Detection component 230 of system 50, as executed by computer system/server 12, is configured to analyze a current social media post to determine which, if any, of the predetermined factors apply to the social media post. Consider the following example described below. FIG. 4 shows an example social media post 400. The example Facebook® post states that each person viewing the post may receive 5 free movie tickets to an Acme Entertainment Group cinema. Similar to the process used to determine the factors, post 400 is analyzed to determine which, if any, of the 5 factors determined by analysis component 210 apply to post 400.

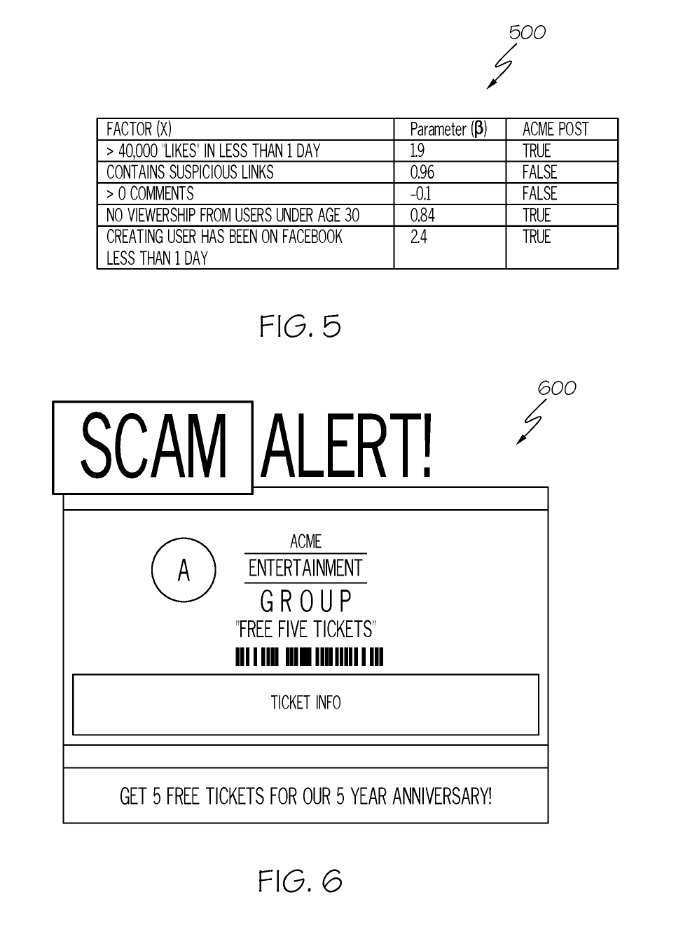

The actual content of post 400 is parsed to retrieve any text, names, addresses, disclaimers, links (e.g., external URL), and the like. In addition, metadata (e.g., creator(s), title, description, date/time of post, etc.) of post 400, use and/or viewership related to the post including likes, shares, comments, analysis between two or more social media platforms, and/or any known “red flags” are gathered. The information is analyzed against the factors to determine the likely validity of post 400. FIG. 5 shows table 500 including how the factors apply to post 400. As shown, factors 1, 4, and 5 are determined to apply. The parameters associated with these applicable factors are aggregated to get the predictor value. Therefore, using the MLF component 220 function, detection component 230 determines a 75% likelihood the social media post is a scam because the predictor value=1.9+0.84+2.4=5.14, where any predictor value greater than 3.1 indicates such a likelihood.

Repudiation component 240 of system 50, as executed by computer system/server 12, is configured to indicate a repudiation of social media content based on a result received from detection component 230. FIG. 6 shows an example social media post 600 including a scam alert. In the Acme example, repudiation component 240 indicates a potential scam related to the Acme Entertainment Group cinema ticket giveaway to warn potential viewers that the post is potentially a scam. A scam may trick users into giving over their personal and financial information which may be used by fraudsters. In an embodiment, a scam alert image or scam warning message such as the alert shown in FIG. 6 may be displayed through the social media site on the potentially fraudulent post. In other words, a transformed social media post (i.e., an original social media post including a scam alert) for a social media post deemed to be a potential scam may be written back to social media server 280, so that any future display of the social media post on a display of user device 290 shows a scam alert (e.g., social media post 600).

In another embodiment, another type of action may be taken, such as notifying a company or user via an informational message (e.g., via email, comment, social media instant message, etc.) depicted in the post of the potential scam using their identifying information (e.g., name, logo, likeness, etc.).

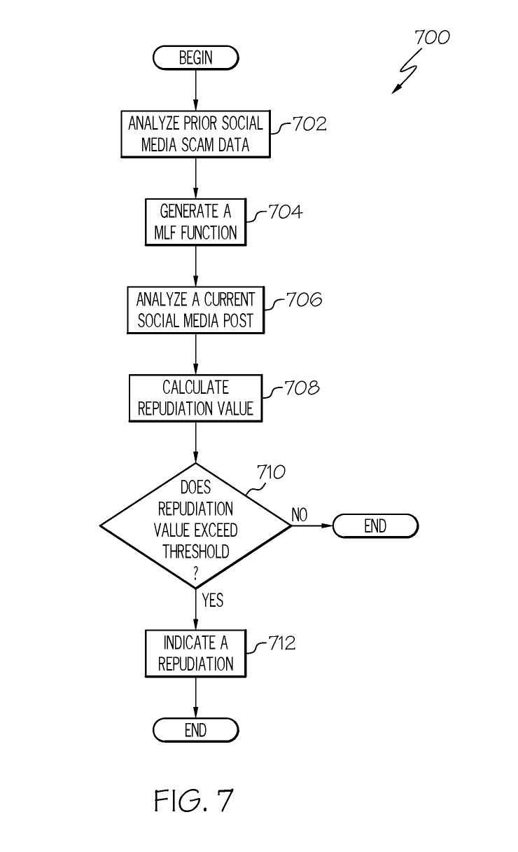

Referring now to FIG. 7, in conjunction with FIG. 2, an implementation of a process flowchart 700 for identifying a deceptive social media post such as a fraudulent social survey in a social media environment is shown. At step 702, analysis component 210 analyzes prior social media scam data using regression analysis to generate a regression model including one or more factors. Each factor includes a respective parameter indicating a strength of association for determining whether a particular social media post is a scam. At step 704, machine learning framework component 220 generates a predictor function including a threshold value based on the regression model. At step 706, detection component 230 analyzes a current social media post to determine which, if any, of the predetermined factors apply to the social media post. Based on this determination, at step 708, detection component 230 calculates a repudiation value using the predictor function. At step 710, a determination is made whether the repudiation value exceeds the threshold value. If so, at step 712, repudiation component 240 provides an indication of repudiation related to the current social media post being analyzed.

Process flowchart 700 of FIG. 7 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for identifying a deceptive social media post such as a fraudulent social survey in a social media environment. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for identifying a deceptive social media post such as a fraudulent social survey in a social media environment. In this case, the service provider can create, maintain, support, etc., a computer infrastructure that performs the process steps of the invention for one or more consumers. In return, the service provider can receive payment from the consumer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (for example, the Internet, a local area network, a wide area network and/or a wireless network). The network may comprise copper transmission cables, optical transmission fibers, wireless transmission, routers, firewalls, switches, gateway computers and/or edge servers. A network adapter card or network interface in each computing/processing device receives computer readable program instructions from the network and routes the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an document of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

It is apparent that there has been provided herein approaches for identifying a deceptive social media post such as a fraudulent social survey in a social media environment. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for repudiating social media content, the method comprising:
receiving a predictor function, wherein the predictor function includes one or more factors, wherein each of the one or more factors includes a respective parameter;
analyzing a social media post to determine whether at least one of the one or more factors applies to the social media post;
calculating, based on the analysis, a repudiation value for the social media post using the predictor function; and
providing a repudiation of the social media post when the repudiation value exceeds the threshold value.

2. The computer-implemented method of claim 1, wherein the social media post is a social survey.

3. The computer-implemented method of claim 1, further comprising:
generating, based on an analysis of prior social media scam data, a regression model, wherein the prior social media scam data includes data related to a set of prior social media scam posts; and
generating, based on the regression model, the predictor function.

4. The computer-implemented method of claim 3, wherein the data related to a prior social media scam post among the set of prior social media scam posts is selected from a group consisting of: a content, metadata, interactions, and one or more red flags associated with the set of prior social media scam posts.

5. The computer-implemented method of claim 4, wherein the one or more red flags are identified using at least one of natural language or image processing techniques.

6. The computer-implemented method of claim 1, wherein the repudiation is selected from a group consisting of displaying a scam alert image, displaying a scam warning message, or notifying a company or person referenced in the social media post.

7. The computer-implemented method of claim 1, wherein calculating a repudiation value includes analyzing the social media post to determine whether any of the factors apply to the social media post.

8. A computer program product for repudiating social media content, and program instructions stored on the computer readable storage device, to:
receive a predictor function, wherein the predictor function includes one or more factors, wherein each of the one or more factors includes a respective parameter;
analyze a social media post to determine whether at least one of the one or more factors applies to the social media post;
calculate, based on the analysis, a repudiation value for the social media post using the predictor function; and
provide a repudiation of the social media post when the repudiation value exceeds the threshold value.

9. The computer program product of claim 8, wherein the social media post is a social survey.

10. The computer program product of claim 8, further comprising computer instructions to:
generate, based on an analysis of prior social media scam data, a regression model, wherein the prior social media scam data includes data related to a set of prior social media scam posts; and
generate, based on the regression model, the predictor function.

11. The computer program product of claim 10, wherein the data related to a prior social media scam post among the set of prior social media scam posts is selected from a group consisting of: a content, metadata, interactions, or one or more red flags associated with the set of prior social media scam posts.

12. The computer program product of claim 11, wherein the one or more red flags are identified using at least one of natural language or image processing techniques.

13. The computer program product of claim 8, wherein the repudiation is selected from a group consisting of displaying a scam alert image, displaying a scam warning message, or notifying a company or person referenced in the social media post.

14. The computer program product of claim 8, further comprising program instructions to calculate a repudiation value based on an analysis of the social media post to determine whether any of the factors apply to the social media post.

15. A computer system for repudiating social media content, the computer system comprising:
a memory medium comprising program instructions;
a bus coupled to the memory medium; and
a processor for executing the program instructions, the instructions causing the system to:
receive a predictor function, wherein the predictor function includes one or more factors, wherein each of the one or more factors includes a respective parameter;
analyze a social media post to determine whether at least one of the one or more factors applies to the social media post;
calculate, based on the analysis, a repudiation value for the social media post using the predictor function; and
provide a repudiation of the social media post when the repudiation value exceeds the threshold value.

16. The computer system of claim 15, wherein the social media post is a social survey.

17. The computer system of claim 15, further comprising program instructions to:
generate, based on an analysis of prior social media scam data, a regression model, wherein the prior social media scam data includes data related to a set of prior social media scam posts; and
generate, based on the regression model, the predictor function.

18. The computer system of claim 17, wherein the data related to a prior social media scam post among the set of prior social media scam posts is selected from a group consisting of: a content, metadata, interactions, or one or more red flags associated with the set of prior social media scam posts.

19. The computer system of claim 18, wherein the one or more red flags are identified using at least one of natural language or image processing techniques.

20. The computer system of claim 15, wherein the repudiation is selected from a group consisting of displaying a scam alert image, displaying a scam warning message, or notifying a company or person referenced in the social media post.
